(19) United States
(12) Patent Application Publication
(10) Pub. No.: US 2017/0275999 A1
(43) Pub. Date: Sep. 28, 2017

(54) CMC TURBINE BLADE PLATFORM DAMPER

(71) Applicant: General Electric Company, Schenectady, NY (US)

(72) Inventor: Matthew Mark Weaver, Loveland, OH (US)

(21) Appl. No.: 15/079,072

(22) Filed: Mar. 24, 2016

(51) Int. Cl. F01D 5/22; F01D 25/06; F01D 5/28

(52) U.S. Cl. CPC F01D 5/22; F01D 5/282; F01D 25/06; F05D 2220/32; F05D 2260/96

(57) ABSTRACT

Damping systems are provided for a rotor blade platform. The damping system may include a blade platform defining a damper pocket and a CMC wedge damper positioned within the damper pocket. The CMC wedge damper has at least one damper angled surface parallel to a longitudinal axis. The damper pocket comprises a pocket angled surface positioned about the at least one damper angled surface.

### FIELD OF THE INVENTION

The present disclosure generally involves damping vibrations in a turbine. In particular embodiments, the damping system may be used to damp vibrations on the platforms of adjacent rotating blades made from ceramic matrix composite (CMC) materials using a CMC wedge damper.

### BACKGROUND OF THE INVENTION

Turbines are widely used in a variety of aviation, industrial, and power generation applications to perform work. Each turbine generally includes alternating stages of peripherally mounted stator vanes and rotating blades. The stator vanes may be attached to a stationary component such as a casing that surrounds the turbine, and the rotating blades may be attached to a rotor located along an axial centerline of the turbine. A compressed working fluid, such as steam, combustion gases, or air, flows along a hot gas path through the turbine to produce work. The stator vanes accelerate and direct the compressed working fluid onto the subsequent stage of rotating blades to impart motion to the rotating blades, thus turning the rotor and performing work.

Each rotating blade generally includes an airfoil connected to a platform that defines at least a portion of the hot gas path. The platform in turn connects to a root that may slide into a slot in the rotor to hold the rotating blade in place. Alternately, the root may slide into an adaptor which in turn slides into the slot in the rotor. At operational speeds, the rotating blades may vibrate at natural or resonant frequencies that create stresses in the roots, adaptors, and/or slots that may lead to accelerated material fatigue. Therefore, various damper systems have been developed to damp vibrations between adjacent rotating blades. In some damper systems, a metal rod or damper is inserted between adjacent platforms, adjacent adaptors, and/or between the root and the adaptor or the rotor. At operational speeds, the weight of the damper seats the damper against the complementary surfaces to exert force against the surfaces and damp vibrations.

Higher operating temperatures generally result in improved thermodynamic efficiency and/or increased power output. Higher operating temperatures also lead to increased erosion, creep, and low cycle fatigue of various components along the hot gas path. As a result, ceramic material composite (CMC) materials are increasingly being incorporated into components exposed to the higher temperatures associated with the hot gas path.

However, as CMC materials become incorporated into the airfoils, platforms, and/or roots of rotating blades, the ceramic surfaces of the rotating blades more readily abrade with conventional metallic dampers. The increased abrasion of the CMC material by the metallic dampers may create additional foreign object debris along the hot gas path and/or reduce the mass of the dampers, reducing the damping force created by the dampers. Therefore, an improved system for damping vibrations in a turbine would be useful.

### BRIEF DESCRIPTION OF THE INVENTION

Aspects and advantages of the invention will be set forth in part in the following description, or may be obvious from the description, or may be learned through practice of the invention.

Damping systems are generally provided for a rotor blade platform. In one embodiment, the damping system includes a blade platform defining a damper pocket and a CMC wedge damper positioned within the damper pocket. The CMC wedge damper has at least one damper angled surface parallel to a longitudinal axis. The damper pocket comprises a pocket angled surface positioned about the at least one damper angled surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figures, in which:

FIG. 1 is a schematic cross-sectional view of an exemplary gas turbine engine in accordance with an embodiment of the present disclosure;

FIG. 2 is an enlarged circumferential cross sectional side view of a high pressure turbine portion of a gas turbine engine in accordance with an embodiment of the present disclosure;

FIG. 3 is an axial view of two adjacent exemplary CMC rotor blade assemblies and an exemplary CMC;

FIG. 4 is a sectional view of the exemplary CMC damper of FIG. 3 between the CMC rotor blade assemblies;

FIG. 5 is a plan view of an exemplary pocket formed between two adjacent platforms;

FIG. 6 is a perspective view of an exemplary embodiment of a CMC damper;

FIG. 7 is a perspective view of another exemplary embodiment of a CMC damper;

FIG. 8 is a perspective view an exemplary CMC turbine blade assembly showing the tabbed CMC damper; and

FIG. 9 is a perspective view of an exemplary triangular groove configured as a damper pocket on the CMC blade assembly platform.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to moving in a direction toward the engine exhaust nozzle, or a component being relatively closer to the engine exhaust nozzle as compared to another component.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component. As used herein, the terms “lateral” or “laterally” refer to a dimension that is perpendicular to both the axial and radial dimensions.

All directional references (e.g., radial, axial, proximal, distal, upper, lower, upward, downward, left, right, lateral, front, back, top, bottom, above, below, vertical, horizontal, clockwise, counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

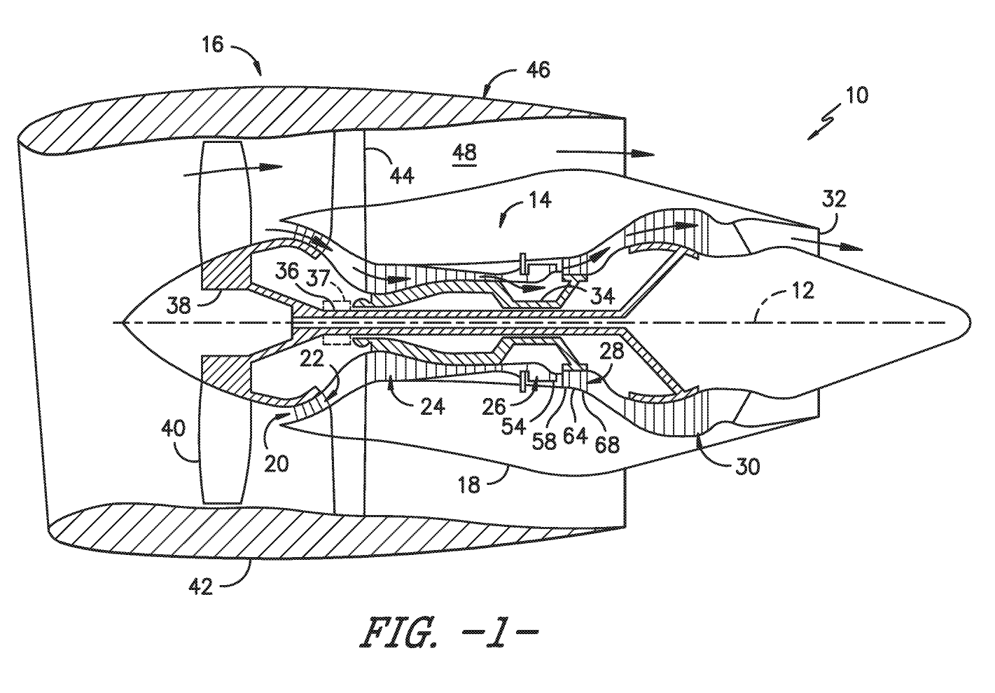

Referring now to the drawings, FIG. 1 is a schematic cross-sectional view of an exemplary high-bypass turbofan type engine 10, herein referred to as “turbofan”, as may incorporate various embodiments of the present disclosure. As shown in FIG. 1, the turbofan 10 has a longitudinal or axial centerline axis 12 that extends therethrough for reference purposes. In general, the turbofan 10 may include a core turbine or gas turbine engine 14 disposed downstream from a fan section 16.

The gas turbine engine 14 may generally include a substantially tubular outer casing 18 that defines an annular inlet 20. The outer casing 18 may be formed from multiple casings. The outer casing 18 encases, in serial flow relationship, a compressor section having a booster or low pressure (LP) compressor 22, a high pressure (HP) compressor 24, a combustion section 26, a turbine section including a high pressure (HP) turbine 28, a low pressure (LP) turbine 30, and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. The (LP) spool 36 may also be connected to a fan spool or shaft 38 of the fan section 16. In particular embodiments, the (LP) spool 36 may be connected directly to the fan spool 38 such as in a direct-drive configuration. In alternative configurations, the (LP) spool 36 may be connected to the fan spool 38 via a speed reduction device 37 such as a reduction gear gearbox in an indirect-drive or geared-drive configuration. Such speed reduction devices may be included between any suitable shafts/spools within engine 10 as desired or required.

As shown in FIG. 1, the fan section 16 includes a plurality of fan blades 40 that are coupled to and that extend radially outwardly from the fan spool 38. An annular fan casing or nacelle 42 circumferentially surrounds the fan section 16 and/or at least a portion of the gas turbine engine 14. It should be appreciated by those of ordinary skill in the art that the nacelle 42 may be configured to be supported relative to the gas turbine engine 14 by a plurality of circumferentially-spaced outlet guide vanes 44. Moreover, a downstream section 46 of the nacelle 42 (downstream of the guide vanes 44) may extend over an outer portion of the gas turbine engine 14 so as to define a bypass airflow passage 48 therebetween.

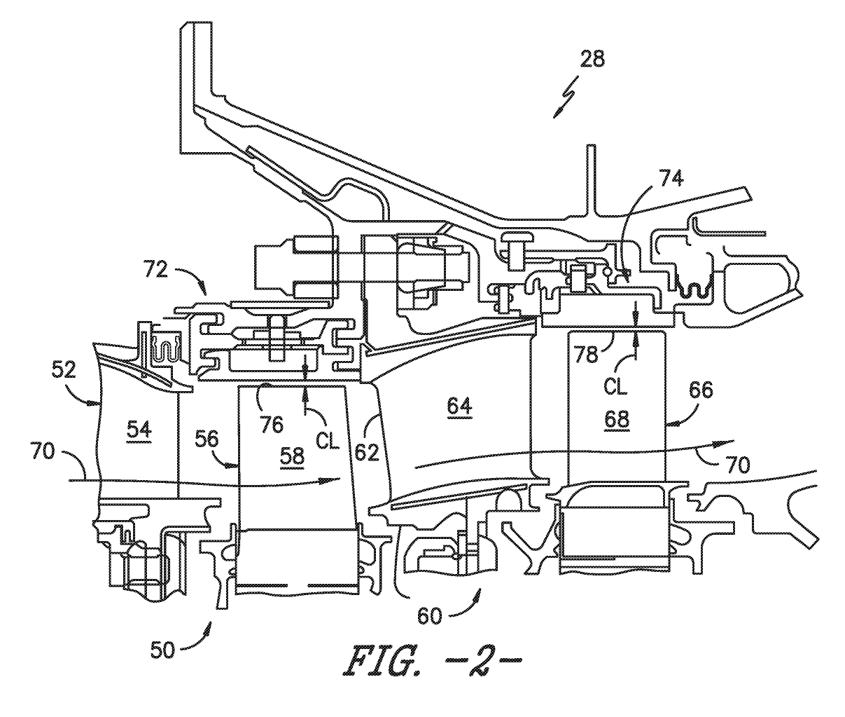

FIG. 2 provides an enlarged cross sectioned view of the HP turbine 28 portion of the gas turbine engine 14 as shown in FIG. 1, as may incorporate various embodiments of the present invention. As shown in FIG. 2, the HP turbine 28 includes, in serial flow relationship, a first stage 50 which includes an annular array 52 of stator vane nozzles 54 (only one shown) axially spaced from an annular array 56 of turbine rotor blade assembly 58 (only one shown). The HP turbine 28 further includes a second stage 60 which includes an annular array 62 of stator vane nozzles 64 (only one shown) axially spaced from an annular array 66 of turbine rotor blades 68 (only one shown). The turbine rotor blade assemblies 58, 68 extend radially outwardly from and are coupled to the HP spool 34 (FIG. 1). As shown in FIG. 2, the stator vane nozzles 54, 64 and the turbine rotor blade assemblies 58, 68 at least partially define a hot gas path 70 for routing combustion gases from the combustion section 26 (FIG. 1) through the HP turbine 28.

As further shown in FIG. 2, the HP turbine may include one or more shroud assemblies, each of which forms an annular ring about an annular array of rotor nozzles. For example, a shroud assembly 72 may form an annular ring around the annular array 56 of rotor blade assembly 58 of the first stage 50, and a shroud assembly 74 may form an annular ring around the annular array 66 of turbine rotor blade assembly 68 of the second stage 60. In general, shrouds of the shroud assemblies 72, 74 are radially spaced from blade tips 76, 78 of each of the rotor blade assembly 68. A radial or clearance gap CL is defined between the blade tips 76, 78 and the shrouds.

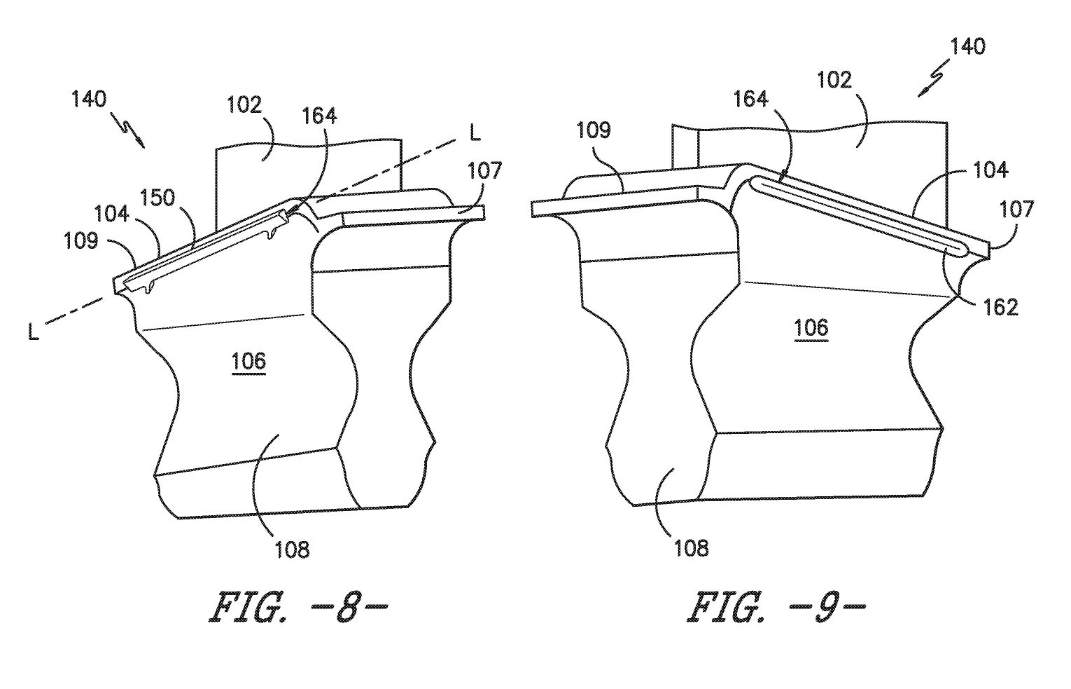

Referring now to FIG. 3, each of the CMC rotor blade assemblies 100a, 100b include an airfoil portion 102, a platform portion 104, and a shank portion 106 with a dovetail attachment mechanism 108. The CMC rotor blade assemblies 100a, 100b also include an axially upstream, or forward angel wing 107 and an axially downstream, or aft angel wing 109 (see FIGS. 8 & 9).

During engine operation, vibrations are induced in and between the CMC rotor blade assemblies 100a, 100b including side-to-side, i.e., circumferential movement of the platform portions 104 that increase excitation stresses induced in the shank portions 106. A platform damping system 140 is positioned between adjacent portions of the platform portions 104. In the exemplary embodiment shown, CMC rotor blade assemblies 100a, 100b are unitarily formed as a single component via those CMC fabrication processes known in the art. However, in other embodiments, the CMC rotor blade assemblies 100a, 100b may be formed from separate components.

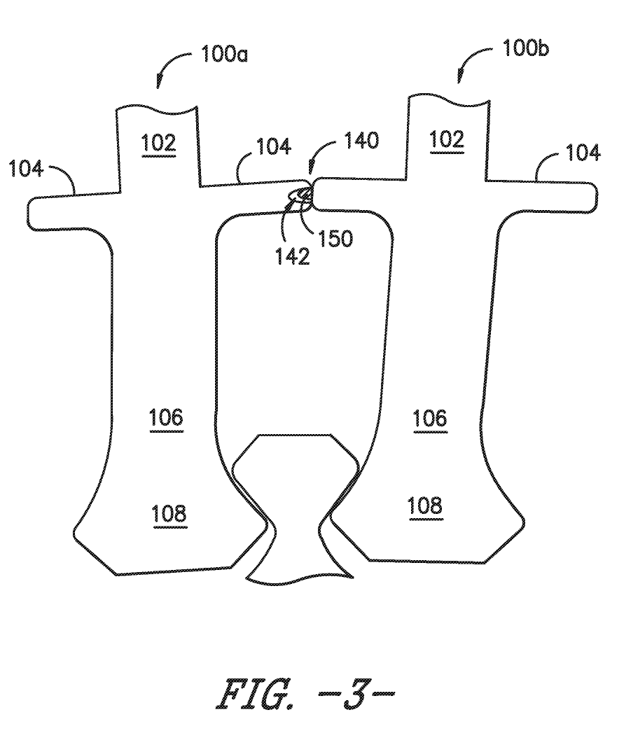

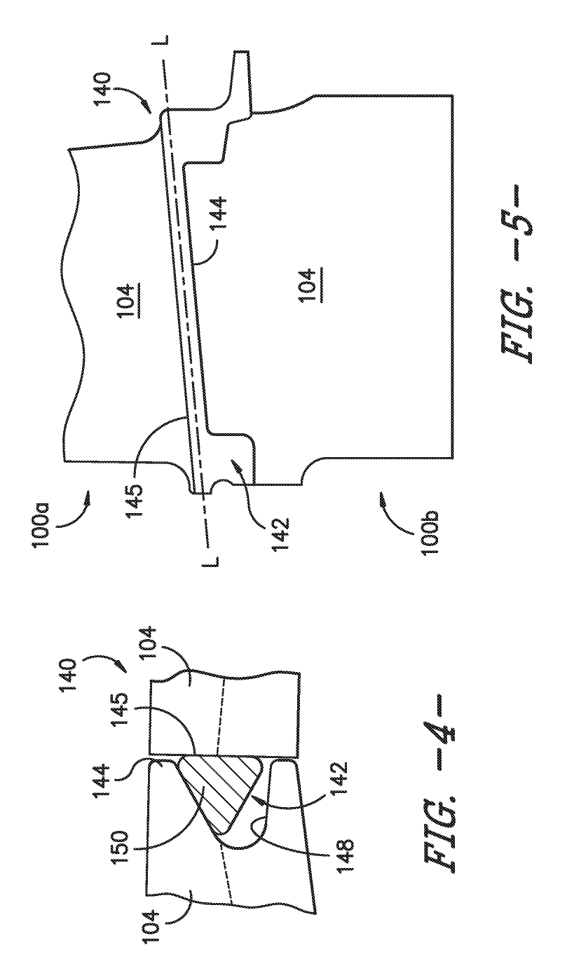

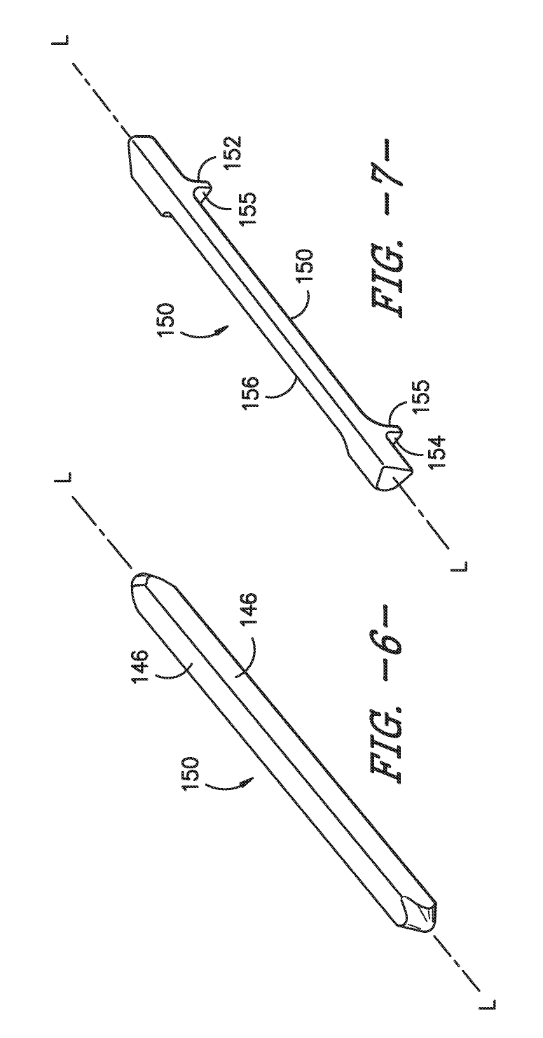

FIGS. 4 and 5 show an exemplary damping system 140 utilized between the adjacent CMC rotor blade assemblies 100a, 100b. As shown in FIG. 4, a CMC wedge damper 150 is generally shown defining a substantially triangular shape and positioned within a damper pocket 142 defined on the platform portion 104 of at least one of the CMC rotor blade assemblies 100a, 100b. However, other shapes can be utilized with a corresponding pocket shape. For example, FIG. 5 shows a CMC wedge damper 150 having a substantially triangular shape and including a pair of tabs 152, 154, and the damper pocket 142 in FIG. 5 illustrates an exemplary shape to house the wedge damper shown in FIG. 7.

In the embodiments shown in FIGS. 4 and 5, the damper pocket 142 is defined within the convex side 144 of the blade platform portion 104. Through this positioning, the damper pocket 142 can allow for sufficient clearance between each pocket angled surface 148 and a damper angled surface 146 about the CMC wedge damper 150 to allow movement of the wedge damper 150 when the CMC wedge damper 150 is positioned within the damper pocket 142. When the wedge damper 150 is propelled radially outward in the damper pocket 142 by centrifugal force, it assumes a consistent equilibrium position with a damper angled surface 146 slidingly engaging both a pocket angled surface 148 (i.e., the outer pocket angled surface) and the concave side 145 of the platform portion 104 of the adjacent CMC rotor blade assemblies 100a, 100b to dissipate vibrational energy in the CMC rotor blade assemblies 100a, 100b. The damper pocket 142 in FIG. 5 illustrates an exemplary shape to house the wedge damper shown in FIG. 7.

FIGS. 6 & 7 illustrate exemplary CMC wedge dampers 150. Each of the CMC wedge dampers 150 generally have a triangular shaped body extending along a longitudinal axis L with at least one damper angled surface 146 parallel to the longitudinal axis L. As seen in FIG. 7, the CMC wedge damper 150 can also have a leading tab 152, a trailing tab 154, and/or a notched corner 156. The leading tab 152, trailing tab 154 and notched corner 156 can be configured to offset the center of gravity of the wedge damper 150 to help control the positioning of the CMC wedge damper 150 during use. Additionally, the leading tab 152 and trailing tab 154 can prevent the CMC wedge damper 150 from sliding out of the pocket in the longitudinal direction during turbine operation. As shown, the trailing tab 154 and leading tab 152 have at least one tab angled surface 155 transverse to the longitudinal axis L. The leading tab 152 can be formed with at least one of a contact prong and a rounded crown. The trailing tab 154 can also be formed to have a protrusion. However, other shapes can be utilized for the tabs 152, 154. Additionally, other features can be utilized on or within the body of the wedge damper 150.

Referring to FIGS. 8 & 9, two embodiments of the damping system 140 are shown that each include a triangular groove 162 formed into a flat vertical face 164 of platform portion 104. Triangular groove 162 can be formed by any method that enables operation of the damping system 140 as described herein. In the exemplary embodiment, CMC wedge damper 150 nests in the triangular groove 162 when installed. CMC wedge damper 150 is sized, configured, and oriented on a flat vertical face 164 of a first platform portion 104 to be at least partially received and retained within triangular groove 162 of an adjacent flat vertical face 164. Both the damper pocket 142 and triangular groove 162 are sized to receive and retain CMC wedge damper 150 without coupling methods such as welding, brazing, and fastener hardware.

In particular embodiments, the CMC wedge damper 150 is constructed from a CMC material that is similar to and/or compatible with the CMC material of the CMC rotor blade assemblies 100a, 100b. For example, the CMC material may be a silicon based, non-oxide ceramic matrix composite. As used herein, “CMCs” refers to silicon-containing, or oxide-oxide, matrix and reinforcing materials. Some examples of CMCs acceptable for use herein can include, but are not limited to, materials having a matrix and reinforcing fibers comprising non-oxide silicon-based materials such as silicon carbide, silicon nitride, silicon oxycarbides, silicon oxynitrides, and mixtures thereof. Examples include, but are not limited to, CMCs with silicon carbide matrix and silicon carbide fiber; silicon nitride matrix and silicon carbide fiber; and silicon carbide/silicon nitride matrix mixture and silicon carbide fiber. Furthermore, CMCs can have a matrix and reinforcing fibers comprised of oxide ceramics.

An example of the damping performance of the CMC wedge damper 150 illustrates a new class of turbine blade vibratory damping response as compared to current metal dampers. Modeling results for the new CMC wedge damper determined that scaling up the damper stiffness to simulate the CMC material with a modulus ratio of 40.3/13=3.1, and scaling down the mass of the damper to simulate the CMC material with a density ratio of 0.102/0.317=0.32, the CMC wedge damper provided at least four times the undamped critical location vibratory response stress reduction of an otherwise identical damper but for being made from metals comprising superalloys of aluminum, iron, nickel, titanium, cobalt, chromium or mixtures thereof. These results apply for an undamped critical location stress of at least 4000 psi.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A damping system for a rotor blade platform, comprising:
a blade platform defining a damper pocket; and
a CMC wedge damper positioned within the damper pocket, wherein the CMC wedge damper comprises at least one damper angled surface parallel to a longitudinal axis, and wherein the damper pocket comprises a pocket angled surface positioned about the at least one damper angled surface.

2. The damping system of claim 1, wherein the CMC wedge damper provides at least four times the undamped critical location vibratory response stress reduction of an otherwise identical damper but for being made from metals comprising superalloys of aluminum, iron, nickel, titanium, cobalt, chromium or mixtures thereof.

3. The damping system of claim 1, wherein the undamped critical location stress is at least 4000 psi.

4. The damping system of claim 1, wherein the blade platform comprises a convex side, and wherein the damper pocket is positioned within the convex side.

5. The damping system of claim 1, comprising an adjacent blade platform defining a concave side wherein the wedge damper engages with the pocket angled surface and the concave side of the adjacent platform portion.

6. The damping system of claim 5, wherein the concave side comprises a triangular groove.

7. The damping system of claim 6, wherein the wedge damper is at least partially received and retained within triangular groove.

8. The damping system of claim 1, wherein the CMC wedge damper comprises a leading tab and a trailing tab.

9. The damping system of claim 8, wherein the leading tab comprises at least one of a contact prong and a rounded crown.

10. The damping system of claim 8, wherein the trailing tab comprises a protrusion.

11. The damping system of claim 1, wherein the wedge damper comprises a notched corner.

12. A damping system for a turbine blade platform, comprising:
a blade platform defining a damper pocket; and
a CMC wedge damper positioned within the damper pocket, wherein the CMC wedge damper comprises a leading tab, a trailing tab and at least one damper angled surface parallel to a longitudinal axis, and wherein the trailing tab and leading tab comprise at least one tab angled surface transverse to the longitudinal axis, and wherein the damper pocket comprises a pocket angled surface positioned about the at least one damper angled surface and the at least one tab angled surface.

13. The damping system of claim 12, wherein the wedge damper comprises an offset center of gravity.

14. The damping system of claim 12, wherein the blade platform comprises a convex side and wherein the damper pocket is positioned on the convex side.

15. The damping system of claim 12, comprising an adjacent blade platform defining a concave side wherein the wedge damper engages with the pocket angled surface and the concave side of the adjacent platform portion.

16. The damping system of claim 12, wherein the wedge damper is at least partially received and retained within damper pocket.

17. The damping system of claim 12, wherein the wedge damper comprises a notched corner.

18. The damping system of claim 12, wherein the leading tab comprises at least one of a contact prong and a rounded crown.

19. The damping system of claim 12, wherein the trailing tab comprises a protrusion.
